(19) United States
(12) Patent Application Publication
(10) Pub. No.: US 2006/0029910 A1
(43) Pub. Date: Feb. 9, 2006

(54) Process for the surface decoration of a cosmetic product

(75) Inventor: Nadia Avalle, Vallese (CH)

Correspondence Address: AKERMAN SENTERFITT, P.O. BOX 3188, WEST PALM BEACH, FL, 33402-3188, US

(73) Assignee: Intercos S.p.A., Milano (IT)

(21) Appl. No.: 10/539,651

(22) PCT Filed: Dec. 5, 2003
(86) PCT No.: PCT/EP03/13981

§ 371 Date: Jun. 14, 2005

(30) Foreign Application Priority Data
Dec. 23, 2002 (IT) MI2002A 002740

(51) Int. Cl. G09B 19/00

(52) U.S. Cl. 434/100

(57) ABSTRACT

For the surface decoration of a cosmetic product (8), one proceeds as follows. One fills a non-shaped cavity (2) with a decorating product (3) and the shaving of the decorating product (3) that is input into said cavity (2) is carried out. A face (5) provided with shapes (6) of a pad (4) of yielding material is inserted and slightly compressed into the decorating product (3) contained inside said cavity (2) so as to make parts (3′) of said decorating product (3) adhere to said shapes (6) of the pad (4). The pad (4). (4) gets then above the cosmetic product (8) to be decorated, positioned and slightly compressed onto the surface of the cosmetic product (8) to be decorated in order to leave on it said parts (3′) of decorating product (3).

The present invention concerns a process for the surface decoration of a cosmetic product.

There are known methods of decoration of the surface of poured cosmetic products with powder or fluid products in order to trace on the surface of the finished cosmetic product drawings and/or writings in various colours in such a way as to create chromatic contrast and to give a pleasant aesthetic effect.

One of such methods provides the spraying of a liquid coloured product, either coloured cosmetic product or pearls, onto the surface of a finished cosmetic product, by making the flow of sprayed product pass through appropriate coloured stencils.

Such system creates low-defined contoured surfaces, with a great waste of product, since the majority of sprayed product gets lost around the stencil and in the environment.

In addition there are many limits in the creation of the shapes since the stencil, generally metallic, is difficult and expensive to make.

Other methods, called “pad decoration”, provide the use of very soft round or conical silicon pads that get pressed on a rigid surface within which shaped containers having the shape to be deposited have previously been obtained and inside which the product to be transported has been deposited. Such pads, by taking the shape of the containers, get impregnated with product which can thus be transported onto another surface.

The deposition onto the base cosmetic product finally takes place still by pressing of the pad onto the same surface and by consequent separation of the coloured product from the pad from the surface of the cosmetic product.

Such system involves mainly two problems:

1) The formation of air pockets in the pick up cavity, caused by the pressure of the pad and by its shaping inside the cavities. The air could cause some product to get out of the cavity and could deposit it also in other zones of the pad, thus marring the figure which remained on the same pad.

2) the deposition of parts of marring coloured product on all the surface of the finished cosmetic product and not exclusively on the part relative to the desired shape. This is caused, besides the previous reason, also by the fact that all the surface that contains the pick-up containers can get dirty with the product to be transported and this, since it is not contained in the single containers any more, stays adherent to the pad in an uncontrolled way.

In view of this state of the art, object of the present invention has been to provide a process for the surface decoration of a cosmetic product, that uses the above described pad decorating technique with such innovative modalities as to obviate to the above described disadvantages.

According to the invention a process has thus been provided that provides the use of variously shaped pads which pick up the product to be deposited from a non-shaped container and subsequently deposit it onto the surface of a cosmetic product made up of pressed powder or of a poured or extruded product.

Such surface is thus decorated with various figures, writings etc., even with various colours different from each other, which create a particularly pleasant visual effect.

The pads are preferably made up of silicon resin with variable hardness and the hardness of the material is a function of the degree of release of the product onto the surface of the finished cosmetic product, as well as of the hardness of the base surface.

The pads can have cylindrical shape or other shape and one of the faces, the one that gets in contact with the product to be transported and with the deposition surface, is opportunely formed with the shape to be impressed onto the finished product.

Such shapes can be made of various designs, writings, etc., monocolour or with more colours.

The product to be transported and to be deposited onto the surface of the finished product can consist of a coloured powder or semifluid cosmetic product or of pearls in powder or semifluid form.

The fluidity of the product to be deposited is a function of the consistency and of the characteristics of the finished product and it is obtained by adding variable amounts of volatile or semivolatile or liquid solvents for cosmetic use to the powder product that will have to be deposited.

The product deposition can be carried out in a single step, and therefore the surface of the finished product will be decorated in monochromatic way or, if the figure must be made in several colours, the transport will take place in several step, in which each time a different colour and, maybe, even a different shape will be picked up. A surface decorated in polychromatic way will thus be obtained.

The finished cosmetic product that will have to be decorated with the transported product can consist of a poured lips red, of a poured gloss (lip gloss), of a compacted extruded product or of a compacted powder product.

Such products can be contained in metallic bases that will then be placed into a final container or directly in the same final container.

An embodiment of the process according to the present invention is illustrated as a non-limiting example in the enclosed drawings, in which:

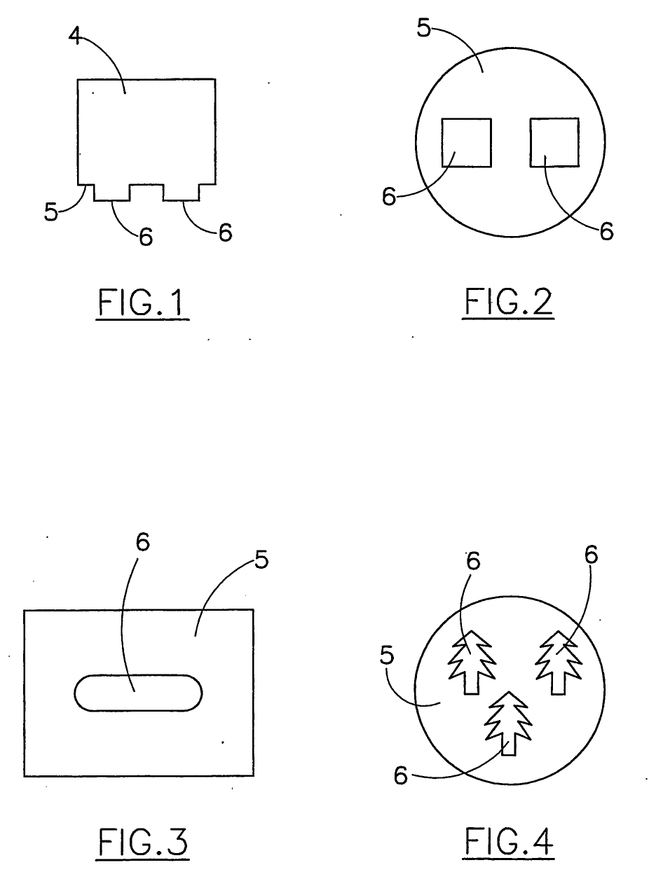

FIGS. 1 and 2 respectively show in side view and bottom plan with a possible shape of pad suitable for the use with the process according to the invention;

FIGS. 3 and 4 show in bottom plan view possible alternative shapes of the pad;

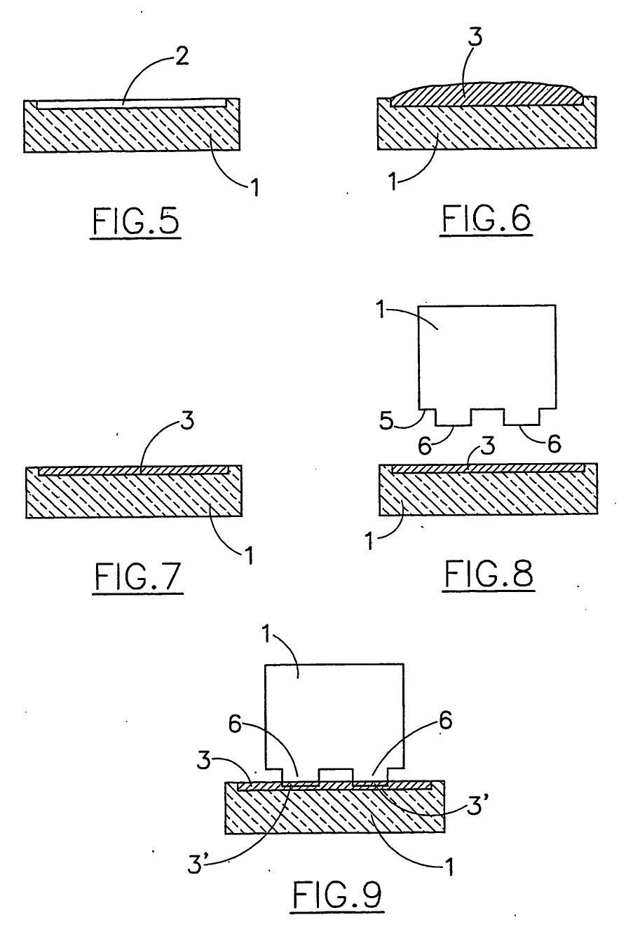

FIGS. 5-11 schematically show in vertical section various steps of the process according to the invention;

FIGS. 12 and 13 respectively show in vertical section and in top plan view the finished cosmetic product with decorated surface.

With reference to the drawings, a metallic base 1 (FIG. 5) with standard shape, preferably equal for all the pads, contains one or more cavities 2, with any shape, preferably round, with depth variable from 0.3 millimetres to 1 millimetre depending on the consistency of the material to be contained.

The cavity 2 is filled (FIG. 6) with the desired product 3, in powder or fluid, that gets subsequently shaved (FIG. 7).

A pad 4 of yielding material, in particular of silicon resin, preferably with cylindrical or parallelepiped shape, with end face 5 provided with relief shapes 6 with the shape each time desired, for example as illustrated in FIGS. 1-4, is lowered down until inside the cavity 2 (FIGS. 8 and 9) where, by slightly compressing the product 3 contained in it, the shaped part 6 gets covered with parts 3′ of the same product.

The aforesaid shaped part of the pad 4 has a greater depth than the one of the cavity 2, therefore inside the same cavity there is no air compression and the surface of the pad that is impregnated is only the one of the shape 6, so as to prevent any product particles from being deposited also on other parts of the pad thus creating dirt around the same shape.

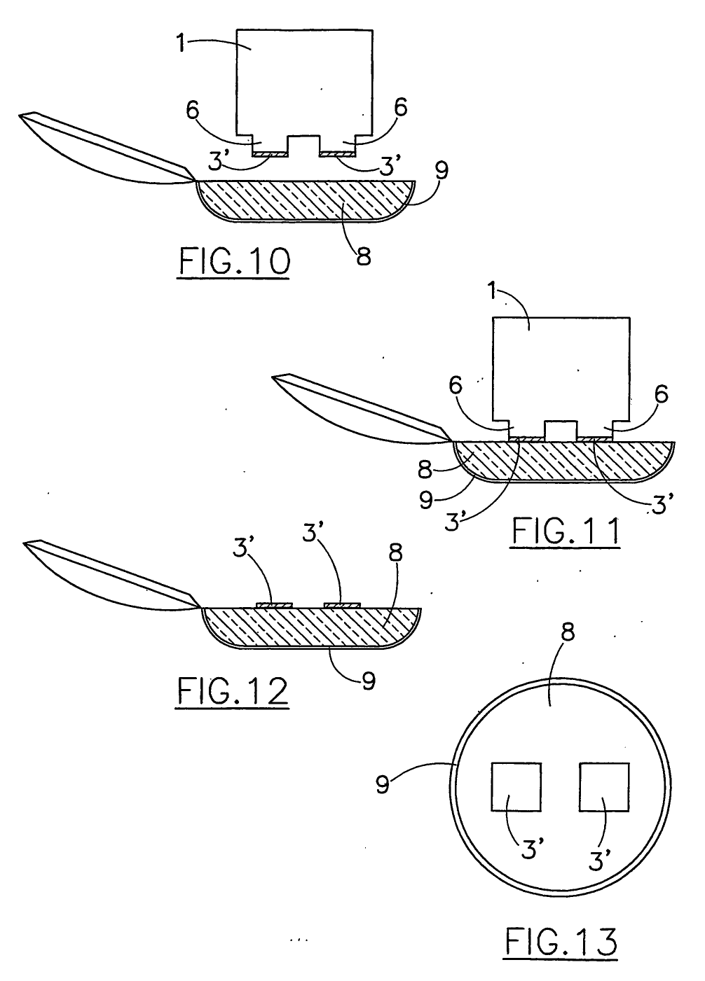

Subsequently the pad is moved onto the cosmetic product to be decorated, illustrated in FIG. 10 inside a container 7 and indicated by the reference number 8. The operation of deposition takes place similarly to what has happened for the picking up, that is by slightly compressing the surface of the cosmetic product 8 that must be decorated (FIG. 11) in such a way that this releases the decorating product 3′ and leaves the surface of the pad clean (FIGS. 12 and 13).

In this way the deposition takes place in an extremely selective way only from the impregnated shape and therefore the result will be much sharper and lacking any lateral dirt.

The pad 4 is finally lifted, thus leaving in the container 9 the cosmetic product 8 with the desired decorations 3′.

The above described operations can be repeated for any number of desired colours.

1. A process for the surface decoration of a cosmetic product, comprising the following sequence of stages:
a) filling of a non-shaped cavity with a decorating product;
b) shaving of the decorating product input into said cavity;
c) insertion and slight compression of a face provided with shapes of a pad of yielding material into the decorating product (contained in said cavity so as to make said parts of decorating product adhere to said shapes of the pad;
d) movement of the pad above the cosmetic product to be decorated;
e) positioning and slight compression of the pad onto the surface of the cosmetic product to be decorated in order to leave on it said parts of decorating product ;
f) removal of the pad from the cosmetic product provided with decorations corresponding to said parts M of decorating product.

2. A process according to claim 1, wherein said shapes project out of said face of the pad in larger measure than the depth of said cavity.

3. A process according to claim 1, wherein said pad is made of silicon resin.

4. A process according to claim 1, wherein said decorating product is made up of a powder or semifluid cosmetic product.

5. A process according to claim 1, wherein said decorating product is made up of pearls in powder or semifluid form.

6. A process according to claim 1, wherein it repeats the stages a) to f) for all the desired colours.

7. A pad of yielding material for the transfer of a decorating product onto a cosmetic product surface to be decorated, wherein it has a face provided with shapes in relief.

8. A process according to claim 2, wherein it repeats the stages a) to f) for all the desired colours.

9. A process according to claim 3, wherein it repeats the stages a) to f) for all the desired colours.

10. A process according to claim 4, wherein it repeats the stages a) to f) for all the desired colours.

11. A process according to claim 5, wherein it repeats the stages a) to f) for all the desired colours.
